(19) United States
(12) Patent Application Publication
(10) Pub. No.: US 2020/0126513 A1
(43) Pub. Date: Apr. 23, 2020

(54) SYSTEM AND METHOD FOR WEB ENABLED APPLICATION EXECUTION AND MANAGEMENT

(71) Applicant: Mythical Labs, Inc., Chestnut Hill, MA (US)

(72) Inventors: Wai Kit Lau, Chestnut Hill, MA (US); Louis William Sivillo, North Kingstown, RI (US)

(21) Appl. No.: 16/653,635

(22) Filed: Oct. 15, 2019

Related U.S. Application Data
(60) Provisional application No. 62/747,016, filed on Oct. 17, 2018.

(51) Int. Cl. G09G 5/14; G06F 3/14; H04N 7/15; H04L 29/08

(52) U.S. Cl. CPC G09G 5/14; G06F 3/1454; G09G 2354/00; H04L 67/02; H04L 67/141; H04N 7/15

(57) ABSTRACT

Embodiments related to systems and methods, including computer program products, for executing web-based applications. A set of applications are executed using a web browser, wherein each application is associated with a content source, the content source comprising a local content source running locally on the system, a remote content source running remotely from the system, or both. A plurality of tiles are displayed using the web browser, wherein each tile is associated with an application from the set of applications, and each tile displays content from the content source of the associated application.

### RELATED APPLICATION

This application claims priority under 35 U.S.C. § 119(e) to U.S. Provisional Application Ser. No. 62/747,016, filed Oct. 17, 2018, entitled “SYSTEM AND METHOD FOR WEB ENABLED APPLICATION EXECUTION AND MANAGEMENT,” which is hereby incorporated by reference in its entirety.

### BACKGROUND

Internet-based teleconferencing systems and videoconferencing systems can allow remotely-located users to conduct shared voice and/or video communication sessions. However, existing technologies often require users to download local applications and/or plug-ins in order to use such services. Additionally, such existing technologies are often limited in the ability to add any additional features to the conference, and/or to customize the conference to meet each user's needs. Further, existing technologies do not provide mechanisms for users to customize their display, and instead limit each user to a common interface that is used by each conference user.

### SUMMARY

Various aspects of the present application relate to web enabled application execution and management. In particular, the techniques can provide users with a single interface, such as a web browser interface (e.g., requiring no download) and/or other application interface (e.g., a mobile and/or desktop application) to an application management system, which allows a user to create a conference room with the specific applications desired by the user. Each application can include an associated tile that renders the content of the application in the interface. The user can add and remove tiles/applications, and can share the tiles with other users. Each user can independently customize their tiled display, and can add tiles for local applications that may (or may not) be shared with other users.

Some aspects relate to a system for executing web enabled applications. The system includes one or more processors configured to: execute, using a web browser, a set of applications, wherein each application is associated with a content source, the content source comprising a local content source running locally on the system, a remote content source running remotely from the system, or both; and display, using the web browser, a plurality of tiles, wherein each tile is associated with an application from the set of applications, and each tile displays content from the content source of the associated application.

In some examples, the one or more processors are configured to: receive a command to share a selected tile from the plurality of tiles with a second system that is remote from the system; and transmit data associated with the content of the selected tile to a remote server over a network, wherein the server is configured to transmit the data to the second system.

In some examples, executing, using the web browser, a set of applications comprises: transmitting a request to a remote server over a network to join an online room associated with the set of applications; establishing a connection to the remote server to join the online room; receiving content for an application of the set of applications from the remote server; and displaying the content in the tile associated with the application.

In some examples, the application is an online video conferencing application, and displaying the content in the tile associated with the online video conferencing application comprises: receiving audio data, video data, or both, associated with a remote system; displaying the audio data, video data, or both in the tile associated with the online video conferencing application; generating, by the one or more processors, local audio data, local video data, or both; and transmitting the local audio data, local video data, or both.

In some examples, transmitting comprises transmitting the local audio data, local video data, or both, to the remote server so that the remote server can transmit the local audio data, local video data, or both to the remote system.

In some examples, transmitting comprises: establishing a peer-to-peer connection with the remote system; and transmitting the local audio data, local video data, or both, to the remote system using the peer-to-peer connection.

In some examples, an application of the set of applications comprises a virtual machine application, wherein executing the virtual machine application comprises: transmitting a request to a remote server to launch a virtual machine; receiving data indicative of information regarding the virtual machine, wherein the virtual machine is running remotely from the system; and connecting to the virtual machine using the received data. The one or more processors can be configured to receive a command to share the tile from the plurality of tiles associated with the virtual machine application with a second system that is remote from the system; and transmit data to the remote server over a network, wherein the server is configured to connect the second system to the virtual machine application.

Some aspects relate to a system for executing web-based applications, the system comprising one or more processors configured to: store, in a database, a set of rooms, wherein each room is associated with a set of applications, and each room can be joined by a plurality of remote systems to collaborate using the set of applications; receive a request from a remote system to connect to a room from the set of rooms; start the room, comprising: executing the set of applications, wherein each application generates associated artifacts during execution; and connecting the remote system to the set of applications so that the remote system can receive content associated with the set of applications; receive a request from a second remote system to connect to the room; connect the second remote system so to the set of applications so that the second remote system can receive the content associated with the set of applications; determine the remote system and second remote system disconnected from the room; terminate the room; and store the artifacts generated by the set of applications.

In some examples, the one or more processors are configured to: receive a request from a third remote system to play back the artifacts associated with the room; and transmit the artifacts to the third remote system for display in a web browser associated with the third remote system.

In some examples, executing the set of applications comprises: executing a first application that generates first content; and executing a second application that processes the first content to generate second content.

In some examples, executing the first application comprises executing a video conferencing application that generates the first content, and the first content comprises video data, audio data, or both.

In some examples, executing the second application comprises executing a visual recognition application that generates the second content based on the video data, wherein the second content comprises data regarding a detected visual aspect of the video data.

In some examples, executing the second application comprises executing a video segmentation application that generates the second content based on the video data, wherein the second content comprises second video data that is segmented according to the video segmentation application.

In some examples, executing the second application comprises executing a transcription application that generates the second content based on the audio data, wherein the second content comprises a transcription of the audio data.

Some aspects relate to computer-implemented method for executing web-based applications, the method comprising: storing, in a database, a set of rooms, wherein each room is associated with a set of applications, and each room can be joined by a plurality of remote systems to collaborate using the set of applications; receiving a request from a remote system to connect to a room from the set of rooms; starting the room, comprising: executing the set of applications, wherein each application generates associated artifacts during execution; and connecting the remote system to the set of applications so that the remote system can receive content associated with the set of applications; receiving a request from a second remote system to connect to the room; connecting the second remote system so to the set of applications so that the second remote system can receive the content associated with the set of applications; determining the remote system and second remote system disconnected from the room; terminating the room; and storing the artifacts generated by the set of applications.

Some aspects relate to at least one non-transitory computer-readable storage medium comprising computer-executable instructions that, when executed by at least one processor of a system, perform a method to execute web-based applications, the method comprising: storing, in a database, a set of rooms, wherein each room is associated with a set of applications, and each room can be joined by a plurality of remote systems to collaborate using the set of applications; receiving a request from a remote system to connect to a room from the set of rooms; starting the room, comprising: executing the set of applications, wherein each application generates associated artifacts during execution; and connecting the remote system to the set of applications so that the remote system can receive content associated with the set of applications; receiving a request from a second remote system to connect to the room; connecting the second remote system so to the set of applications so that the second remote system can receive the content associated with the set of applications; determining the remote system and second remote system disconnected from the room; terminating the room; and storing the artifacts generated by the set of applications.

Some aspects relate to a computer-implemented method for executing web-based applications, the method comprising: executing, using a web browser, a set of applications, wherein each application is associated with a content source, the content source comprising a local content source running locally on the system, a remote content source running remotely from the system, or both; and displaying, using the web browser, a plurality of tiles, wherein each tile is associated with an application from the set of applications, and each tile displays content from the content source of the associated application.

Some aspects relate to at least one non-transitory computer-readable storage medium comprising computer-executable instructions that, when executed by at least one processor of a system, perform a method to execute web-based applications, the method comprising: executing, using a web browser, a set of applications, wherein each application is associated with a content source, the content source comprising a local content source running locally on the system, a remote content source running remotely from the system, or both; and displaying, using the web browser, a plurality of tiles, wherein each tile is associated with an application from the set of applications, and each tile displays content from the content source of the associated application.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram showing an overview of components of an exemplary system for executing web enabled applications according to some embodiments;

FIG. 2A is a schematic diagram showing a detailed overview of components of the exemplary cloud computing environment from FIG. 1, according to an embodiment of the present application.

FIG. 2B is a schematic diagram showing a detailed overview of components of the exemplary cloud computing environment from FIG. 1 in an exemplary configuration, according to an embodiment of the present application.

FIG. 3 shows an exemplary computerized method for executing web enabled applications, according to an embodiment of the present invention.

FIG. 4A is an example of a web browser display with a plurality of tiles, according to an embodiment of the present application.

FIG. 4B illustrates an example of maximizing a tile, according to an embodiment of the present application.

FIG. 4C illustrates an exemplary tile configuration, according to an embodiment of the present application.

FIG. 4D illustrates an exemplary tile configuration, according to an embodiment of the present application.

FIG. 4E shows an exemplary configuration of the tiles of web browser display, according to an embodiment of the present application.

FIG. 5A shows an exemplary room formed around a video conferencing application, according to an embodiment of the present application.

FIG. 5B shows an exemplary room formed around a cloud computer application, according to an embodiment of the present application.

FIGS. 6A-6B show an exemplary messaging flow for a virtual machine web enabled application, according to an embodiment of the present application.

FIG. 7 shows an exemplary messaging flow for a transcription application, according to an embodiment of the present application.

### DETAILED DESCRIPTION

The inventors have recognized and appreciated that existing audio and video conferencing systems are inadequate to meet the needs of today's users. The inventors have developed techniques that provide tile-based displays of applications within an application, such as a web browser, a desktop application, a mobile application, and/or the like. For example, a web browser can be used without requiring the user to download any custom programs and/or plug-ins. The tiling techniques provide an abstraction between the rendered content (e.g., the visual content rendered within the web browser) and the underlying application that feeds content for rendering. Such an abstraction allows for easy sharing of tiles on a per-tile basis. Such an abstraction also allows the tiles to render data from a local application and/or a remote application (e.g., a cloud-based application).

In some embodiments, the techniques can provide web enabled access to a virtual machine. For example, each time a user creates a room and/or a tile within the room, the platform can create a new virtual machine. Unlike known conferencing servers, for example, the tiling-based application execution and management provides complete customizability for each conference room, such that the user can seamlessly add new applications (e.g., whiteboard applications, note applications, transcription applications, and/or the like) into the conference room, and can share each tile so that the other users can actively interact with the shared tile. For example, the platform can provide a tile-based virtual machine that can be simultaneously manipulated by each user in the conference room.

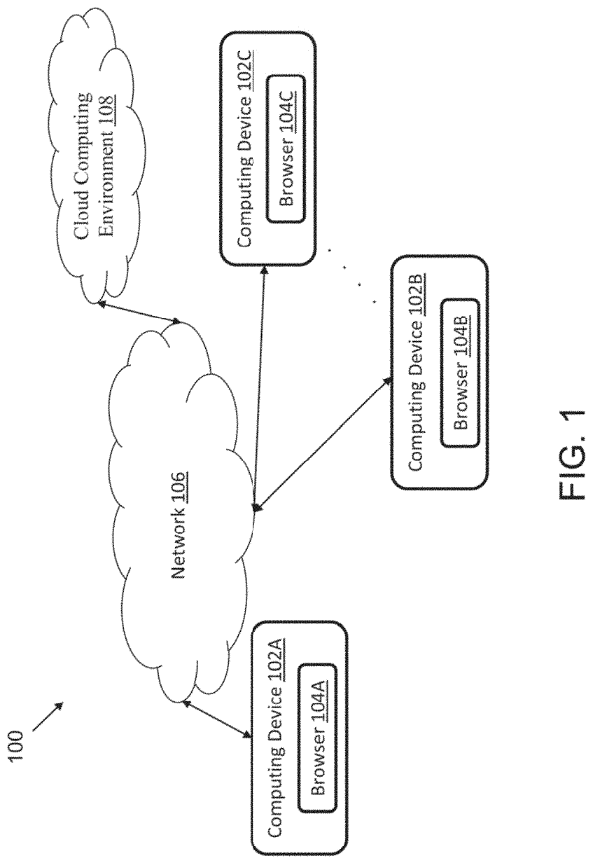

FIG. 1 is a schematic diagram showing an overview of components of an exemplary system 100 for executing web enabled applications, according to an embodiment of the present application. A plurality of computing devices 102A, 102B and 102C (collectively referred to as computing devices 102) are connected to the network 106. Each computing device 102 executes an associated web browser 104A, 104B and 104C, respectively (collectively referred to as a browser 104). The network 106 is in communication with a cloud computing environment 108. As discussed above, the computing device can use a web browser and/or an application, and therefore the discussions herein that refer to web browser 104 are for exemplary purposes only and are not intended to limit how the computing device accesses the cloud computing environment 108.

Referring to the computing device 102, the computing device 102 includes one or more processors configured to execute instructions stored in memory in communication with the one or more processors. The computing device 102 can be a smart phone, tablet computer, desktop computer, laptop computer, and/or any other type of computing device that can access the platform using a web browser and/or application, as discussed herein. The web browser 104 can be configured to communicate with the cloud computing environment 108 using internet-based communications, as discussed herein. Therefore, in some embodiments, the web browser 104 does not require a plug-in to access and/or run applications provided by the cloud computing environment 108.

The network 106 can be any network that can facilitate communications between components, as discussed further herein. Non-limiting examples of such networks include the Internet, a local area network, a wide area network, a wired network, a wireless network (e.g., Bluetooth, WiFi, cellular, etc.), and/or the like.

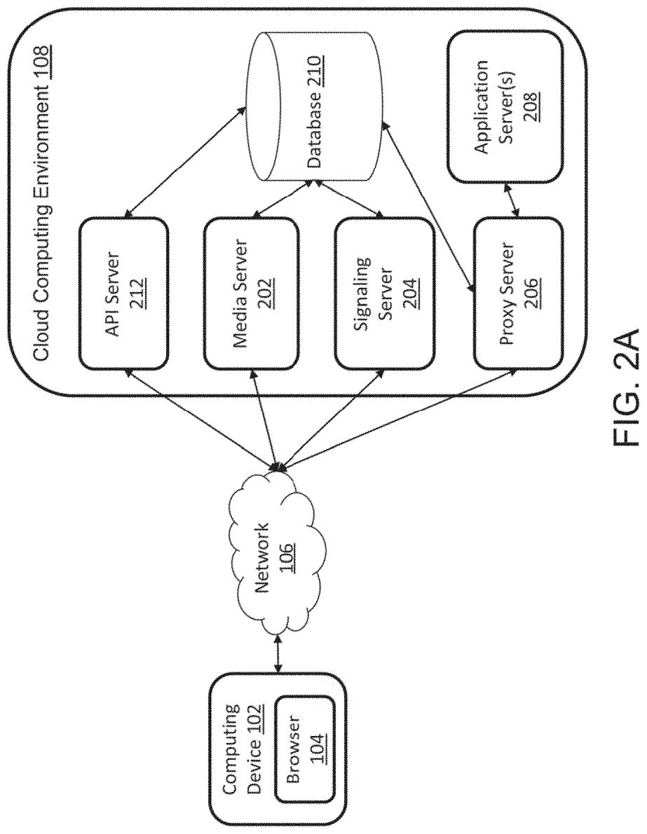

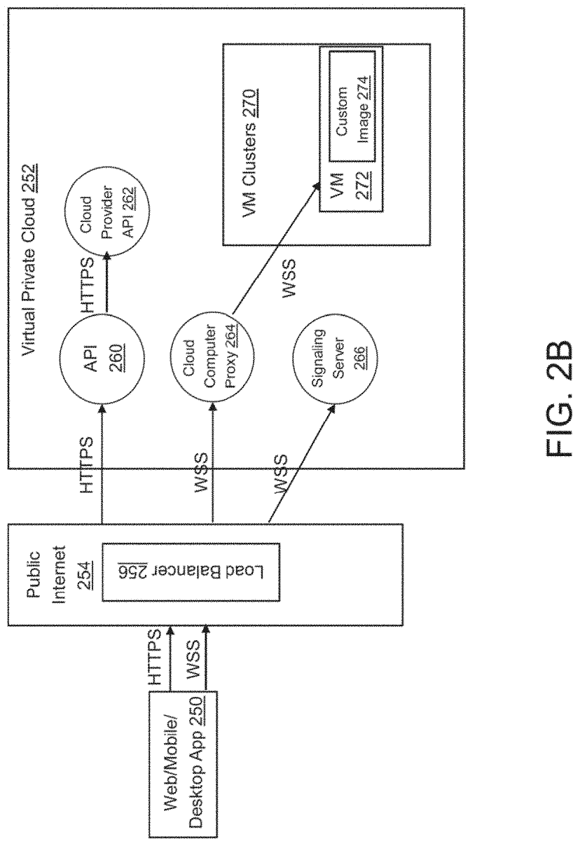

The cloud computing environment 108 can include a set of one or more physical and/or logical computing devices. The cloud computing environment 108 can include, for example, a virtual private cloud. The cloud computing environment 108 can be configured to coordinate executing applications that can be executed by the computing devices 102 and/or shared among the computing devices 102, as discussed in detail herein. FIG. 2A is a schematic diagram showing a detailed overview of components of the exemplary cloud computing environment 108 from FIG. 1, according to an embodiment of the present application. As shown in the example of FIG. 2A, the cloud computing environment 108 includes a media server 202, a signaling server 204, a proxy server 206, and one or more application servers 208. The network 106 is in communication with the media server 202, the signaling server 204, and the proxy server 206. The media server 202, the signaling server 204, and the proxy server 206 are in communication with the database 210. The proxy server 206 is also in communication with the one or more application servers 208.

The media server 202 is configured to provide one or more media applications. The one or more media applications can include, for example, a transcription application, an audio recording and/or video recording application, audio and/or video processing applications (e.g., facial recognition, age/gender recognition, etc.).

The signaling server 204 keeps track of the various user(s) 102 that are accessing applications, as discussed further herein. The signaling server 204 can, for example, keep track of the various rooms provided by the system, and keep track of the users (e.g., computing devices 102) connected to each room at a particular point in time. In some embodiments, the signaling server 204 can facilitate each computing device 102 joining a room. For example, in some embodiments, when a computing device 102 is connecting to a room, the computing device 102 connects to the signaling server 204, and the signaling server 204 provides the computing device 102 with the information necessary to establish a connection to the requested room. For example, the signaling server 204 can send the computing device 102 one or more peer addresses (e.g., of other computing devices 102), and the computing device 102 can establish a peer-to-peer connection with each computing device 102.

In some embodiments, the signaling server 204 can be configured such that it can communicate with the various computing devices 102 connected to each room. Therefore, in addition to other communication sessions that the computing devices 102 maintain to run the applications discussed herein, the computing devices 102 can also maintain a communication session with the signaling server 204. The computing devices 102 can communicate with the signaling server 204 using various communication protocols, such as WebSocket Secure (WSS), a TCP/IP connection (e.g., an open-ended and/or bi-directional TCP/IP connection), and/or the like.

In some embodiments, the signaling server 204 can be configured to share data among room users. For example, a computing device 102 can transmit data that is to be shared among room users to the signaling server 204, and the signaling server 204 can transmit the data to the various user(s) in the room to share the data among those users. For example, a user operating computing device 102 may be running an application locally that the user wishes to share with other users in a room, such as to share the application for viewing by the other users in the room. The user can initiate sharing of that application (e.g., by clicking a share button associated with the tile displaying the application) that causes the computing device 102 to transmit the data to the signaling server 204, which in turn transmits the data to the other computing devices 102 connected to the room. For example, the user can locally run a notes application, an audio and/or video augmentation application, and/or other applications as described herein on their computing device 102 (e.g., which modify the audio and/or video, such as adding sound effects or superimposing video data on top of existing video data), and if the user would like to share the data/application, then the computing device transmits the relevant data to the signaling server 204 for distribution to other computing devices 102 joined into the room. As another example, a screen sharing tile can be implemented using the techniques described herein, which can allow a user to share the user's desktop, an application running on the desktop, and/or the like, with other users.

While FIG. 2A only shows one signaling server 204, this is for exemplary purposes only. In some embodiments, multiple signaling servers can be used in the cloud computing environment 108 (e.g., to allow for scaling and/or provide additional capacity for the platform). The signaling servers can share data among other signaling servers. For example, the signaling servers can use a shared in-memory database. This can allow, for example, different computing devices to be connected to different signaling servers, while still allowing the signaling servers to each know which computing devices are associated with each room at any given time.

Referring to the proxy server 206 and the application server(s) 208, the proxy server 206 facilitates connections between the computing device 102 and a server or computing resource of the application server(s) 208. The computing device 102 can use various protocols to communicate with a computing resource of the application server(s) 208, such as the WSS protocol, TCP/IP, and/or the like. The application server(s) 208 can be a cloud computing environment. As discussed further herein, in some embodiments the application server(s) are configured to run virtual machines that can be shared among the computing devices 102 connected for a particular room. In some embodiments, the signaling server 204, which keeps track of the computing devices 102 joined to a particular room as discussed herein, can inform the computing devices 102 that a virtual machine has been created and is ready for connection.

The database 210 can store a set of conference rooms for the platform. For example, the database 210 set of conference rooms available through the platform. As another example, the database 210 can store access information for rooms. As a further example, the database can store applications available for use in the rooms. As an additional example, the database 210 can store artifacts generated during room run-time, as discussed further herein.

The API server 212 facilitates communication with the application(s) running on the browser 104 of the computing device 102 and the cloud computing environment 108. The browser 104 can communicate with the cloud computing environment 108 using various communication protocols, such as HTTP, HTTPS, RPC, and/or the like. When a user activates a feature of an application running in the browser 104, the browser 104 makes API calls to the API server 212, such as to retrieve data, execute application calls, and/or the like, as will be discussed further herein. In some embodiments, the API server 212 communicates with a second API that is used to retrieve data, execute application calls, and/or the like. For example, the API server 212 can communicate with a web services API (e.g., using HTTP, HTTPS, and/or the like) that executes one or more programs configured to provide functionality of the cloud computing environment 108 to the computing devices 102, as discussed further herein.

In some embodiments, the communications between the cloud computing environment 108 (and its associated components) and the computing devices 102 can be encrypted to provide secure communications. For example, the protocols used between the cloud computing environment components and the computing devices can be transmitted using encrypted and/or secure communications, such as the WSS protocol and HTTPS as discussed above. As another example, stored data (e.g., in database 210, in the application servers 208, etc.) can be encrypted when stored, and transmitted via secure communications protocols. As a further example, the application servers 208 can run in virtual private clouds to securely execute the applications used to feed data to the computing devices.

FIG. 2B is a schematic diagram showing a detailed overview of components of the exemplary cloud computing environment from FIG. 1 in an exemplary configuration, according to an embodiment of the present application. FIG. 2B provides exemplary descriptions of the protocols, custom image details, and cloud API, for illustrative purposes only that are not intended to be limiting. As shown, an application 250 (e.g., web, mobile, or desktop application) communicates with the virtual private cloud 252 using HTTPS and/or WSS through the public internet 254, which includes a load balancer 256. The application 250 communicates with the API 260 via HTTPS, which in-turn communicates with the cloud provider API 262 via HTTPS. The application 250 also communicates with the cloud computer proxy 264 and the signaling server 266 via WSS. The cloud computer proxy 264 communicates with the VM clusters 270, which in this example shows VM 272 with a custom VM image 274. The front end application 250 can run within a web browser using the HTTPS protocol to communicate with the API 260 to retrieve data and make requests. The WSS protocol can be used to establish a connection with the VM 272 via the cloud computer proxy server 264. The signaling server 266 can be used to inform room participants that a cloud computer VM 272 has been created. The custom image 274 can be based off, for example, Ubuntu and can leverage VNC server functionality via noVNC. The cloud provider API 262 can be implementation agnostic so that it can be extensible to work with various cloud providers.

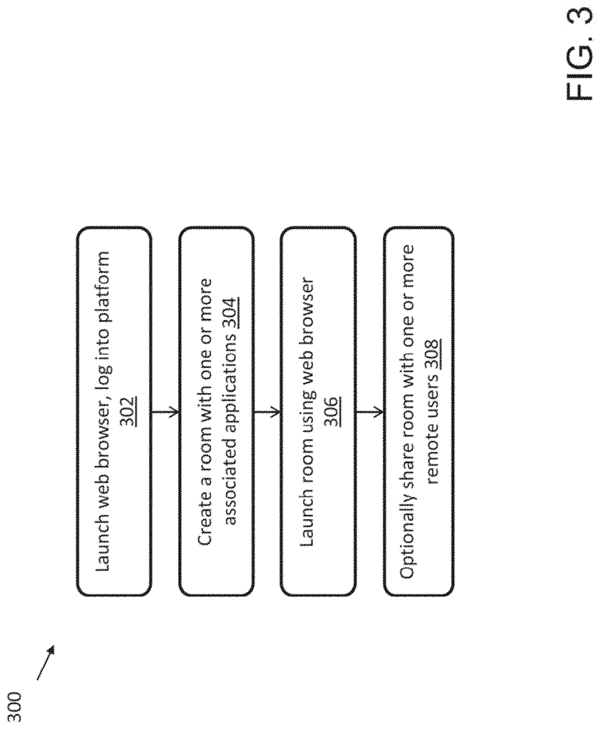

FIG. 3 shows an exemplary computerized method for executing web enabled applications, according to one embodiment of the present invention. At step 302, the user operating the computing device launches the web browser or application and connects to the URL that provides access to the platform (e.g., the cloud computing environment 108). The user may be required to log into the user's account. At step 304, the user creates a room that is associated with a collection of one or more applications. At step 306, the user launches the room through the user's web browser or application. At step 308, the user can optionally share the room with other computing devices. At steps 306 and/or 308, other applications can be launched in the room, as discussed further herein.

Referring to FIG. 2A, the cloud computing environment 108 provides the functionality discussed in conjunction with FIG. 3. The cloud computing environment 108, generally, controls the execution of web-based applications, which are organized into rooms. The database 210 stores the rooms, each of which can be run by a single computing device and/or joined by a plurality of computing devices to allow users of the computing devices to collaborate using the application(s) associated with the room. In some embodiments, the cloud computing environment 108 can use a relational database to store data for the rooms. For example, each room can be stored as a row in a relational database, which can include various information for the room, such as the name of the room, an identifier of the user that owns the room (e.g., the user that created the room), whether the room is locked (e.g., such that a user must be given access to the room prior to being able to join the room), an identifier for the room, and/or the like. In some embodiments, the database can store room policies, which can include, for example, who has access to the room, who can change policy of the room, what permissions a user has when they are in a room (e.g., whether the user can launch/remove tiles, whether the user can view, edit or modify the contents of a tile, and/or the like), how long the room can exist for, how long a specific tile should exist for, statefulness of the applications in the room across sessions (e.g., as discussed further herein), and/or the like. For example, a the room can have a time to live (TTL) for a given user. If a first user creates a room and gives a second user access to the room, the first user can specify a TTL for the second user's access to the room. For example, if access is granted for six days and the second user tries to access the room after six days, the second user can be denied access to the room.

The database can also keep track of information generated when the conference room is used, such as artifacts as discussed further herein. The API server 212 receives a request from a remote system (e.g., a first computing device 102) to connect to an available room. The cloud computing environment 108 starts the room, which includes executing the set of applications for that room (e.g., executing the applications using the media server 202 and/or application servers 208). The cloud computing environment 108 connects the remote system to the set of applications (e.g., via the signaling server 204 and/or the proxy server 206) so that the remote system can receive content associated with the set of applications. The cloud computing environment 108 (e.g., the API server 212, which can check whether the requested user has permission to join the room) receives a request from a second remote system to connect to the room. The cloud computing environment 108 (e.g., the signaling server 204 and/or proxy server 206) connect the second remote system to the room so that the second remote system can receive the content associated with the set of applications. In some embodiments, when the second remote system connects to the room, the cloud computing environment 108 relays the state of the room to the second remote system so that the system can construct the appropriate tiles. The signaling server 204 can monitor computing devices connected to the room to determine when all of the computing devices have left the room such that they are no longer connected to the room. The cloud computing environment 108 can terminate the room once no users are left, and store the artifacts generated by the set of applications, as discussed further herein.

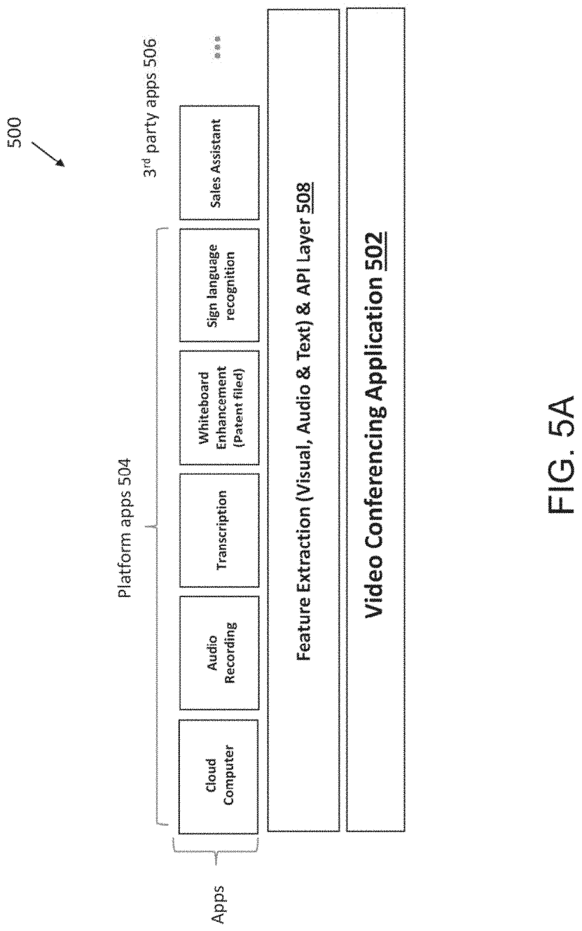

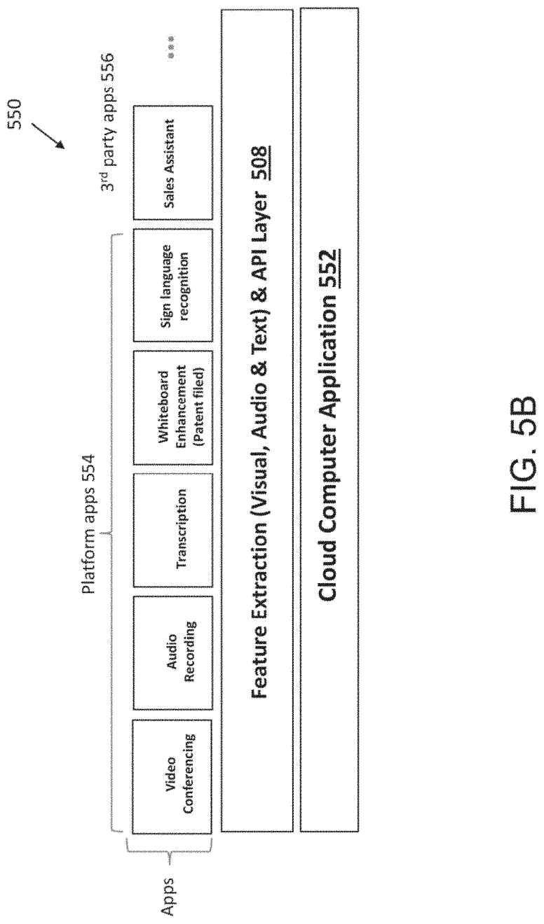

Referring to step 304, in some embodiments, the web page can display a list of available rooms. In some embodiments, if the user has not previously used the platform, the list of rooms may be empty. In some embodiments, the platform can provide a default room that the user can create, e.g., with common functionality that may be of interest to the users. For example, the default room can be a video conferencing room. In some embodiments, the user can be prompted to configure the base application for the room (e.g., video conferencing, computer aided drafting (CAD), a virtual machine, and/or the like, as discussed further herein in conjunction with FIGS. 5A-5B). In some embodiments, the platform can provide a tile marketplace that allows users to browse the various tiles and applications that are available for use (e.g., in a particular room).

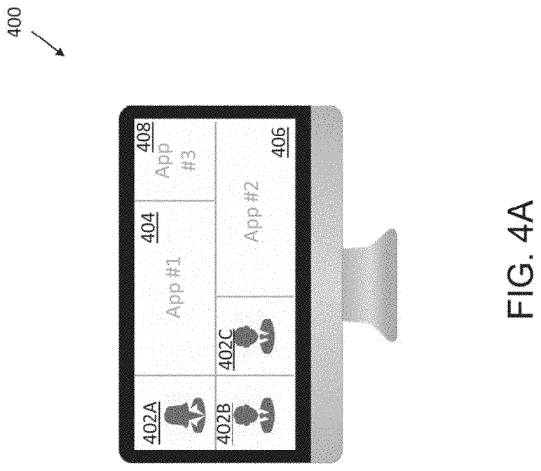

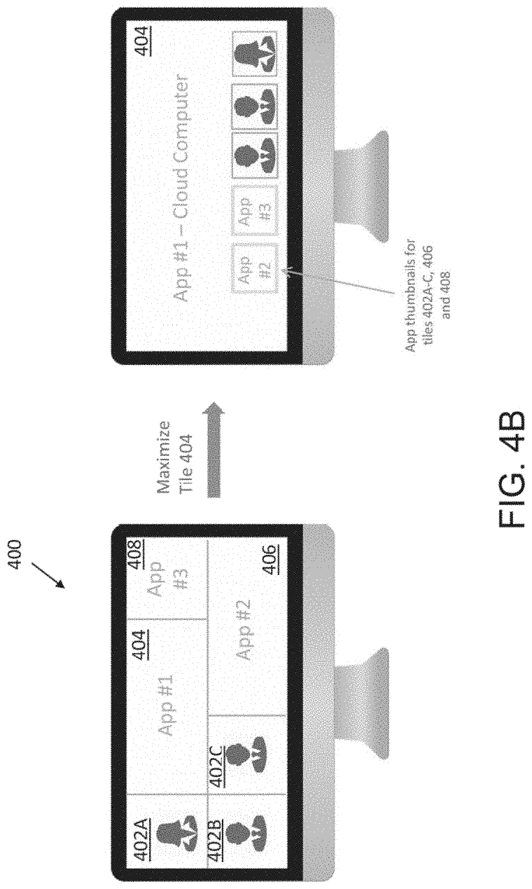

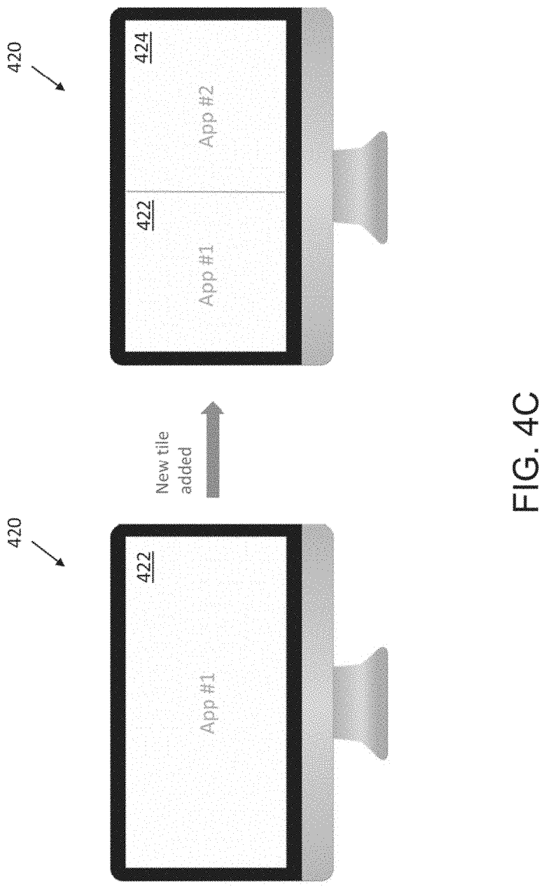

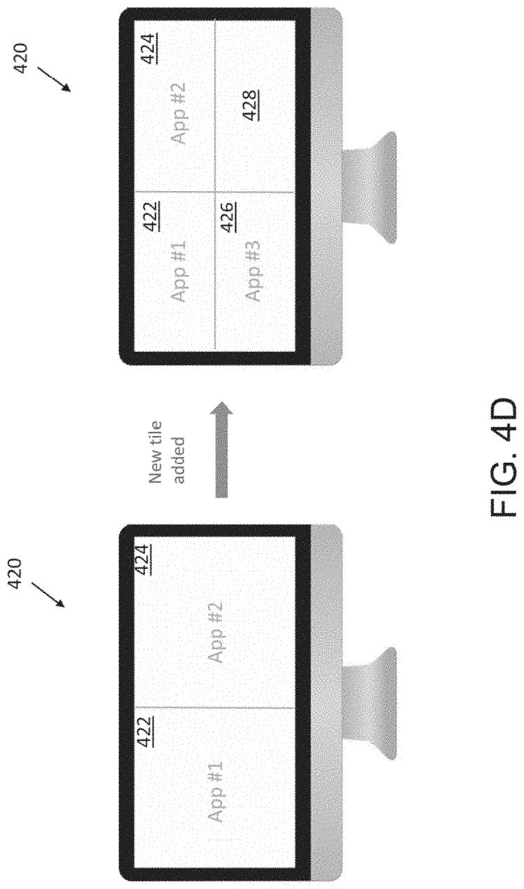

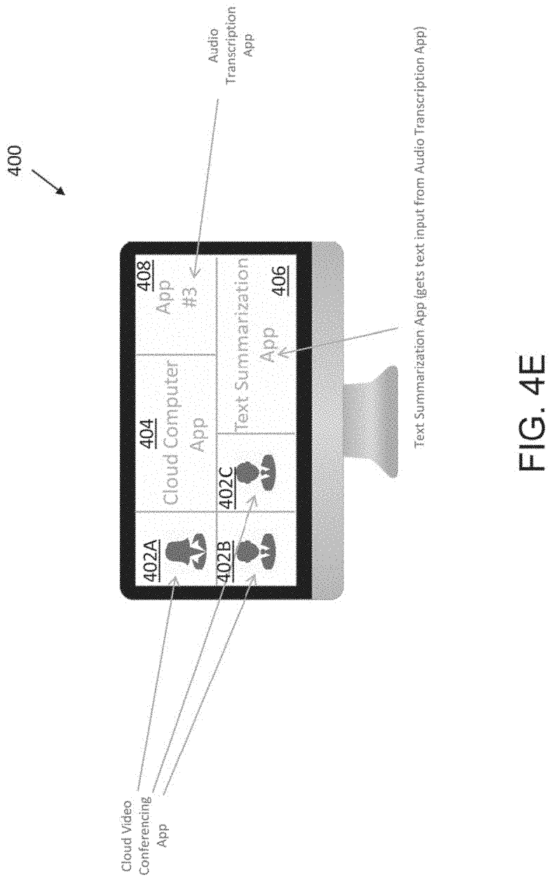

Referring further to step 306, the web browser or application displays data for the set of applications using tiles. Each tile is associated with an application, such that the tile displays content from the content source of its associated application. FIG. 4A is an example of a web browser display 400 with a plurality of tiles, according to an embodiment of the present application. The web browser display 400 includes tiles associated with a video conferencing application, including tiles 402A, 402B, and 402C. The video conferencing application can be configured to display a tile for each participant in the video conferencing session (e.g., such that each user is displayed on an associated tile 402A, 402B, 402C, such that in this example there are three participants in the video conferencing session). As discussed herein, each tile 402A, 402B and/or 402C can be associated with a peer-to-peer connection between the participating computing devices, and/or can be controlled by a central video conferencing server. In some embodiments, a hybrid approach can be used that combines peer-to-peer connections and a central video conferencing server. For example, for a certain minimum number of users (e.g., less than two, less than four, etc.), the system can use peer-to-peer connections among the users for the video conferencing. Once the maximum number of users for peer-to-peer video conferencing is surpassed, the system can configure each computing device with a peer-to-peer connection to the central server to provide the video conferencing data to the central server. The central server can package the data from each computing device into a single source for each computing device, so that each computing device receives the packaged data via its associated peer-to-peer connection with the central server. In some embodiments, the computing devices can be configured to send different data and/or streams to the central server, such as separate audio and/or video streams, and/or different quality streams (e.g., a low-resolution and high-resolution video streams, etc.). The central server can monitor it's connection (e.g., bandwidth, packet loss, etc.) with each computing device to determine the best data to send to each device. For example, if the connection with one computing device is degraded, it may start sending only low-quality video and/or no video (e.g., just audio), whereas it may send full high-resolution audio and video to other computing devices with good connections. The web browser display 400 also includes three additional tiles 404, 406 and 408. As discussed herein, each tile is associated with an application, and in the example display 400, tile 404 is associated with application one, tile 406 is associated with application two, and tile 408 is associated with application three.

Referring further to the web browser display 400, the display can be user-configurable, such that a user can control the size and location of each tile. For example, a user may move tile 402A to the location occupied by tile 406, which causes tile 406 to move to the location occupied by tile 402A. As another example, a user may change the display dimensions of tile 404, which may cause other tiles to change shape as well (e.g., if the user shrinks the width of tile 404, then the display may automatically increase the width of tile 402A and/or tile 408.

FIG. 4B illustrates an example of maximizing a tile, according to an embodiment of the present application. FIG. 4B shows the web browser display 400 from FIG. 4A. In the example shown in FIG. 4B, tile 404 is maximized to occupy the full length and width of the display, while the remaining tiles 402A-C, 406 and 408 are moved to thumbnails in the lower-right corner of the display. The location and organization of the thumbnails is for exemplary purposes only. For example, the thumbnails could be displayed in a different corner and/or corners of the display, may have different shapes (e.g., where a different shape is associated with each type of application), may have different sizes, and/or the like.

In some embodiments, one or more areas of the display can be used as a gutter area to display one or more thumbnails of associated tiles. In some embodiments, the area can be a predetermined location of the screen, such as a margin area on one or more sides of the screen. For example, the gutter area can be an area extending vertically along the right side of the screen, such as a one inch area of the right-side of the screen, two inches of the screen, and/or the like. If there are no thumbnails in the gutter area, then the gutter area may not be displayed so that the tiles can be displayed in the full available space. To cause a first tile to be displayed as a thumbnail in the gutter, a user can drag a desired tile towards the gutter area, which causes the gutter area to be displayed (e.g., such that other remaining tiles are not displayed in the gutter area), displays the tile as a thumbnail in the gutter area, and rearranges the other remaining tiles that are not displayed in the gutter area accordingly, such as described herein. Other tiles can be added to and/or removed from the gutter area. Once the last tile is removed from the gutter area, the gutter area can disappear (e.g., until a tile is added to the gutter area again, causing it to re-appear).

In some embodiments, the web browser display 400 can be configured to use one or more aspect ratios when displaying tiles, where the aspect ratio reflects the ratio of the width of a particular tile to the height of the tile. For example, when the web browser display 400 detects a change to the layout, such as a new tile, a tile move, a tile size change, and/or the like, the web browser display 400 can be configured to compute a best layout aspect ratio to display the tiles in the web browser display 400. For example, the web browser display 400 can compute a set of different layouts, and present the tiles using the layout from the set of layouts that has a best aspect ratio (e.g., a closest aspect ratio for the tiles to a predetermined set of aspect ratios, to a requested aspect ratio, and/or the like).

FIGS. 4C-4D illustrate exemplary tile configurations, according to an embodiment of the present application. Referring to FIG. 4C, the web browser display 420 displays just a single tile 422 (associated with a first application), which occupies the full visible screen of the computing device. When a new tile is added, such as locally by a user and/or remotely by the platform (e.g., in response to a new participant in a video conferencing session), the web browser display 420 determines the best aspect ratio for the two tiles. As shown in FIG. 4C, the web browser display 420 determines that the best aspect ratio is achieved for the tiles when displaying the two tiles 422, 424 side-by-side, as shown. FIG. 4D shows the web browser display 420 with the two tiles 422, 424 from FIG. 4C. When a third tile is added, the web browser display recalculates the display configuration, determining the tile presentation with the best aspect ratio for the tiles. In this example, the web browser display 420 determines that the best aspect ratio is achieved for the tiles by displaying the first two tiles 422, 424 side-by-side on the top row, and the third (new) tile 426 in a new row below the first tile 422. While a portion of the display is blank (portion 428), the web browser display 420 determined that such a configuration maintains a better aspect ratio for the tiles compared to a configuration that occupies all of the available display space (e.g., with the three tiles side-by-side in a single row).

The tiling configuration can be different for each user. In some embodiments, the tiling configuration (e.g., as shown in FIGS. 4A-4D) can be controlled individually by each user, so that the display on a particular computing device is independent of the display(s) of other computing devices connected to the session. In some embodiments, one or more of the tiles may only be displayed locally (e.g., in conjunction with other tiles that are displayed/viewed by multiple browsers/applications). The locally displayed tiles can include content from locally-executed applications and/or content from remote applications. In some embodiments, regardless of the source of the content for the tiles, the tiling configuration for each display is controlled locally, so that each person can configure however that particular person prefers to organize the tiles (e.g., so the user can focus on different tiles, etc.). In some embodiments, the platform may provide the ability for a user, such as an organizer of a room or a current presenter in a video conference, to sync all tile displays with a master display. For example, all tile configurations can be synchronized to match the configuration of the presenter.

By way of general introduction, a tile provides a flexible interface to an associated application. The tile renders data for the application, without requiring that the application be executed in a particular location. The tile itself can also be kept local to a particular computing device, such that the computing device only displays the tile locally, and can also be extended across multiple computing devices so that the tile is displayed on a plurality of devices. Therefore, tiles can provide a mechanism to launch applications within a browser or application (e.g., without requiring that the user download any additional software and/or have knowledge of how the application is being executed). By sharing a tile, the tile can allow multiple people to interact with and collaborate using the application.

The platform can provide access to various types of applications, ranging from content from websites, custom content, programs, and/or the like. In some embodiments, as discussed herein, the platform can provide an audio/video tile for video conferencing applications. In some embodiments, the platform can provide an audio transcription application that transcribes audio content (e.g., from a video conferencing application). In some embodiments, the platform can provide a cloud computing application, which runs a virtual machine on remote resources, as discussed further herein. In some embodiments, the platform can provide an audio recording application that records audio data for one or more computing devices and/or room. In some embodiments, the audio recording application can run in the background for a particular room (e.g., on the media server 202 in FIG. 2A), without a corresponding tile displaying the content. In some embodiments, when an application is running in the background, the application can be presented to a user via a small icon (e.g., with a visual indication, such as a red line and/or the like) to convey that the application is running. In some embodiments, the platform can provide a notes tile, which can allow the user to take notes (e.g., typed notes, hand-written notes using a mouse/touchpad, and/or the like). In some embodiments, the platform can provide a drawing tile. For example, the platform can provide a digital whiteboard tile that can be executed in conjunction with video conferencing tiles that allows the video conference users to draw illustrations to aid in their video conference discussion. As another example, the platform can provide a data application. For example, the application can use an API to receive relevant data, such as stock data and/or data associated with the stock market.

As discussed herein, a tile can be configured to receive data from any type of application, and to display the data as desired for presentation to the user. A tile can therefore provide a separation between where the content is rendered (e.g., locally on the computing device through the browser/application), and where the content comes from (e.g., a local application, a remote application, a P2P connection, and/or the like). This separation between content and display allows the platform to present tiles locally on a computing device, and if the user desires, to share those tile(s) out to other computing devices associated with a room. For example, the signaling server 204 can receive a message from a first computing device 102 to launch a new tile on other computing devices 102 within the room. The signaling server can send the content to the computing devices 102 to render the content of the tile, so that each computing device can render the tile and display the content from the first computing device 102 (e.g., such that all of the computing devices 102 render the tile in the same way).

Unlike traditional client and server-based applications, the techniques allow a browser to interface with the application. For example, for an application that traditionally needs to be run locally, consuming resources of the local computing device, the application can be launched on a remote virtual machine in the cloud computing environment 108. Thus, the application can be executed in a desktop environment executing in the cloud (e.g., using the application servers 208) and presented to the user through a web-based display via a tile associated with the application. As another example, a tile can be used to easily present content within an organization, or to users of that organization, while maintaining that content within the organization (e.g., rather than needing to re-locate the content to different servers, resources, etc.). For example, an organization may maintain a private data server. The data server can be associated with a tile while allowing the organization to maintain the private data server within the organization. For example, to expose data from the private data server to a tile, the platform can provide an agent that runs on the private data server that facilitates sending the data to a tile. Since such data may be sensitive and/or confidential, the platform can provide various security measures to control access to the data. For example, the platform can be configured to only allow access to authenticated users, to encrypt the data, and/or the like, in order to maintain the security of the data.

In some embodiments, the platform can provide a peer-to-peer video conferencing application. For example, each computing device participating in the videoconferencing session can be connected to the other computing device using peer-to-peer connections. Referring to FIG. 1, for example, while not shown, setting up a videoconference between the computing devices 102A-C requires establishing peer-to-peer connections among the computing devices. For example, computing device 102A would receive audio and video data from the other computing devices 102B-C, and would display A/V data from each computing device in a tile associated with each computing device. Additionally, the computing device 102A would generate locally its own A/V data and transmit that data to each of computing devices 102B-C (which, in turn, render the A/V data in a tile associated with computing device 102A).

In some embodiments, one or more servers and/or computing resources (e.g., cloud computing resources) can provide the videoconferencing functionality. For example, each computing device can connect to, and communicate with, the videoconferencing service rather than over separate peer-to-peer connections with each participating device. For example, referring to FIG. 1, computing device 102A would connect to a videoconferencing resource in the cloud computing environment 108 to receive A/V data associated with computing devices 102B-C, and display the received A/V data in a tile associated with each computing device. The computing device 102A would send locally generated A/V data to the resource in the cloud computing environment 108, which would facilitate transmitting that A/V data to the computing devices 102B-C.

In some embodiments, a virtual machine application can provide a virtual machine tile for web enabled access to the virtual machine. In some embodiments, the virtual machine tiles can be used as interactive computing sessions for a room, such that each computing device can control the functionality of the virtual machine (e.g., mouse, keyboard, applications, and/or the like). In some embodiments, the platform can provide for policies regarding storing virtual machine data. For example, the policy can be configured to store associated data for a predetermined time period, and/or to delete any associated data when the virtual machine session has ended (e.g., all users log off and/or close the tile). In some embodiments, the associated data can include data indicative of the state of the virtual machine and its associated applications, so that the user can open and close the virtual machine tile and the state of the virtual machine tile persists over time. Therefore, each time the user opens the virtual machine tile, the virtual machine has the same state as the last time the user closed the tile (e.g., same open web pages, open applications, state of applications, stored files, etc.). Such a feature can be used to provide a virtual computing device to the user through the virtual machine tile.

Since the platform facilitates launching the virtual machine through a web browser or other application, the platform can provide users with an easy mechanism to create a virtual machine instance compared to prior techniques. For example, some companies may have a dedicated virtual machine team to handle requests for virtual machines (e.g., for engineers to use for testing, etc.). Such infrastructures can create a significant lead-time for virtual machine creation, especially since the engineers may not be familiar with how to create the virtual machine instance. The web-based virtual machine tile/app provides an easily executed virtual machine, essentially through the click of a button.

In some embodiments, the virtual machine can be pre-configured, such as to include basic functionality (e.g., just web browser functionality), advanced functionality (e.g., a specific operating system, specific applications, etc.), and/or the like. In some embodiments, the platform can allow users to specify custom virtual machines for additional ease of virtual machine creation. For example, the platform can allow users to specify aspects of the virtual machine, such as the physical location that will run the virtual machine (e.g., for speed), the operating system, installed applications, etc. In some embodiments, the virtual machine(s) run for a particular room and/or customer can be customized to execute custom virtual machine images (e.g., on a per-client basis, on a per-room basis, and/or the like). In some embodiments, a standard virtual machine image can also be provided for use, which can include basic virtual machine components. For example, the virtual machine image can include a pre-configured operating system, such as UNIX, Windows, Ubuntu, and/or the like. As another example, the virtual machine image can include certain functionality, such as VNC server functionality, as discussed further herein.

In some embodiments, to allow users to customize their own virtual machine, the users can extend a base virtual machine image. The base virtual machine image can include software that allows the virtual machine to be displayed in a tile in a manner that allows multiple users to (e.g., simultaneously) manipulate the virtual machine and/or programs being run by the virtual machine. For example, if the virtual machine displays a text editor, the various users can simultaneously use the text editor to collaborate together. As described herein, various applications can be collaborative and allow multiple users in a room to work on the same application. The techniques can provide for such collaboration based on the type of application. In some embodiments, a server (e.g., a WebSocket server) can be used to relay messages among the multiple users to provide for multi-user collaboration. For example, for a notes application tile, the system can leverage a WebSocket server to relay messages back and forth between users. The messages can contain information such as who is typing, what they are typing, when they are typing, and/or the like. The messages can be used to control who is typing (e.g., if one user is typing, the system can disallow other users from typing; when the user is no longer typing, the system can allow others to type). In some examples, the WebSocket server and associated messaging can be used to provide a distributed locking layer to control simultaneous access and prevent collisions. In some embodiments, software applications can be installed and used to relay messages among the multiple users to provide for multi-user collaboration. For example, for a shared browser/VM, software can be installed into the base VM image to enable sharing and collaboration. The software can be capable of muxing/relaying key strokes and mouse movements to all users connected to the shared browser/VM.

A user can extend the base image to include additional customized functionality, such as different applications, operating systems, preferences, processes, software, and/or the like. The specified functionality can be incorporated such that it is running within a remote compute resource when it is launched/executed (e.g., as part of a room). By extending the base image, the user's extended virtual machine image will also have the necessary software to provide the virtual machine in a tile in a manner such that the virtual machine can be shared by the various users (e.g., during a video conference). For example, a user may want to have proprietary software running within a tile at the time it is launched. The platform can allow the user to specify where the system can locate the proprietary software so that the system can install the software within the custom image when the tile is launched. The custom content, such as the custom software, can be provided in various ways. For example, a remote location can be provided that identifies a scripting file that, when executed, will install the proprietary software on the remote compute resource. As another example, a container registry location of an image (e.g., that is derived from a base image) can be launched when the user starts the remote compute resource.

In some embodiments, a user can provide the contents of their own computing resources for a tile. For example, a company may have their own custom (e.g., on premise) computing resources in an internal data center running, and configure the platform to pipe the contents into a tile. In some embodiments, the internal resources can be provided to a tile by installing a software agent that runs on the internal computing resources/server. Once the agent is up and running, the platform can stream the contents of the compute resource into a tile. The software agent can be linked to the appropriate tile using an app registration process. For example, an API and GUI can be used to perform a registration process that can allow users to specify information about their app. The information can include information about the agent, such as the name and the location of their tile contents (for example, an external URL). As described herein, such specified information can be persisted in the system database(s). When a user launches this registered app, the platform can dynamically create the tile and pipe in the contents using the provided URL. As another example, a user's laptop/desktop can be a computing resource that is interfaced with a tile. The user can install the agent on their laptop, which can pipe the contents of their own desktop into a tile (e.g., where other people can control it synchronously or asynchronously). The agent can allow external users to connect to the machine to control content. For example, the agent can include programming/logic to allow connected users to control the machine.

In some embodiments, a file sharing tile can be provided that can allow users of a room to upload a file so that it can be downloaded by other users of the room. For example, the file sharing tile can include a space to enter content to upload (e.g., a file search feature), as well as a space showing any file(s) uploaded for sharing as part of the room. In some embodiments, any files added to a file sharing tile can be stored as part of the artifacts saved for a particular room, as described further herein.

In some embodiments, the platform can provide an application programming interface that allows users (e.g., third parties) to develop new applications and associated tiles for use with the platform. The API can provide users with the ability to access various types of data from other applications, such as audio and/or video data, or other types of data. The API can also allow a user to tie into the platform to control how the tile is launched, when the tile is launched, and/or the like. In some embodiments, the platform can allow users to install new applications in the system. For example, applications can be delivered in a package of one or more programs, as are necessary to implement the application. For example, the display portion for the tile can be programmed in HTML, JavaScript, and/or the like, while the executable portion of the application can be programmed in common programming languages, such as C, C++, Java, and/or the like (e.g., where the executable portion is running in the media server in the cloud). In some embodiments, a programmer and/or third party developer can design a tile to connect to a server application in the cloud. The server application can be configured to consume various artifacts, as discussed further herein (e.g., audio and/or video, and transcriptions, etc.).

In some embodiments, the API can allow an application to use content that is local on the computing device and/or received directly by the computing device. For example, as discussed herein, some implementations may be configured such that the computing device generates its own local A/V content and/or receives content directly from other computing devices (e.g., via peer-to-peer connections). Applications can be created such that the applications can process the audio and/or visual data, or other data, that is local on the machine. In some embodiments, each source of data can have a unique identifier, which can allow the application to individually process data on a per-application basis. For example, a video augmentation application (e.g., which superimposes an image on the video data) can be created such that the application runs locally on the computing device and processes local video data to superimpose the image. The application can also be configured to share the superimposed image with other computing devices, e.g., by communicating with the signaling server. The application can, for example, transmit the data to the signaling server, and the signaling server can transmit the data to the other connected computing devices.

A room can be configured in different ways, such that different applications may serve as the base of the room. In some embodiments, a videoconferencing application can serve as the base of the room. For example, as shown in FIG. 5A, a room can be formed around a video conferencing platform, where the base application for the room is a video conferencing application 502. A user can add additional platform-provided applications 504 (e.g., a cloud computer application, an audio recording application, a transcription application, a whiteboard application, an audio and/or video processing application, such as a sign language recognition application), and/or third party applications 506 (e.g., a sales assistant, in this example). Box 508 represents the feature extraction and API layer. Box 508 represents the various APIs that can be exposed, such as APIs for applications and/or for third party developers. For example, a company can design custom applications that can be configured to run in the background on all company-related rooms. Advantageously, the platform can provide a highly-customizable video conference with additional (sharable) applications, all being displayed via tiles in a single display, such as a web browser display.

In some embodiments, other applications can be the base for a room. In some embodiments, a user can use other applications as the base for a room in a manner that allows the user to use tiles and associated applications privately (e.g., without sharing those tiles/applications with other users). For example, a user may just run a virtual machine tile that is configured to persist the state of the virtual machine over time in order to provide a user with essentially a virtual computer that can be accessed through any web browser. A user can configure an associated room accordingly, and therefore use the techniques described herein to essentially provide a private virtual computer. Even if initially configured privately, the flexibility of the techniques described herein allow a user to add a tile to incorporate social functionality, such as video conferencing, screen sharing, and/or the like.

For example, as shown in FIG. 5B, a room can be formed around a cloud computer application 552. As discussed in conjunction with FIG. 5A, a user can add additional platform-provided applications 554 (e.g., a video conferencing application, an audio recording application, a transcription application, a whiteboard application, an audio and/or video processing application, such as a sign language recognition application), and/or third party applications 556 (e.g., a private database interface, in this example). Advantageously, a user can customize each room as desired, without being restricted in the associated applications. For example, if a user typically accesses certain applications and/or resources each day, the user can create a room to serve as a shortcut to the user instead having to separately access and/or launch each application/resource. For example, if a user typically accesses four different web resources, the user can configure a room to launch four tiles, each associated with a virtual machine, and to have each virtual machine launch an associated web resource using the browser of the virtual machine. As discussed herein, each room can be associated with a single unique URL. Therefore, instead of the user having to separately enter the URL of each web resource, the user can simply access the URL of the room, which automatically launches each web resource and displays the content in an associated tile. Therefore, a room can be configured as a sort of daily landing page that runs all configured applications of interest for the user.

Referring to step 306, when launching a room the web browser or application executes a set of applications. A user can also optionally choose to add additional applications at this point as well. Each application is associated with a content source that provides data for the application. The content source can include, for example, a local content source that is running locally on the computing device executing the web browser, and/or a remote content source that is running remotely from the computing device. As discussed herein, a room (and its associated application(s)) is active from the time when the first remote device joins the room to the time when the last remote device leaves the room. While a room is active, the application(s) of the room can generate various artifacts, such as member information, chat messages, shared notes (e.g., which can later be downloaded), audio transcripts, audio streams, video streams, virtual machines (and/or associated data, such as an interaction log of users with the virtual machine), and/or the like. The artifacts associated with a particular room can be stored in the database 210 and/or another database (e.g., a database provide by the application servers 208). The database can be, for example, a SQL-like database, where the room has an associated start and end time, and has artifacts associated with it. The database can store information regarding the computing devices and/or associated users that participated in the room, such as an account/user name, a peer-ID of the computing device, and/or the like. The database can store contextual data for each artifact, such as when the artifact was created, who it was created by, and/or the like.

The artifacts of a room can be stored and provided in a manner that allows the room to be played back at a later time. For example, the cloud computing environment can receive a request from a computing device to play back the artifacts associated with the room, and the cloud computing environment can transmit the artifacts to the computing device (e.g., for playback and/or display in a web browser or other application). In some embodiments, the artifacts can allow a room to be re-created, such as to re-create a meeting. The techniques can include features that allow the playback to skip to a certain time or timeframe within the playback (e.g., a specific point in time, spoken word, phrase, and/or the like). Therefore, the artifacts can be used in a sense to create a full transcript of the various content and events associated with the room. In some embodiments, a text transcript can be displayed for the room. The transcript can be time-synchronized with the other events in the room, such that the transcript can be rendered in lock-step with, e.g., the audio recording for the room. In some embodiments, the transcript can indicate additional information beyond the audio content, such as data of user activities, including information regarding when each person joined the room, left the room, muted their microphone, muted their audio, etc.

The system can be configured to perform analytics and/or tracking of room, tile and/or application use. In some embodiments, the system can capture, track and analyze the usage of a room and its various tiles. Examples of data that can be tracked can include, for example, what applications are opened, the duration for which each application is open, who viewed/edited an application, artifacts (e.g., such as those discussed herein and/or a video recording of the entire session that can be captured in the background), and/or the like. Such data can be captured and maintained to provide, for example, an audit log for the various activities that occur within a room.

As discussed above for each room, each application may generate associated data, whether it be audio data, video data, and/or other data. An application can process data associated with one or more other applications. As discussed herein, the platform API can provide access to the various data for an application. For example, a transcription application or a translation application can consume audio data associated with an application and/or room that the application uses to generate the transcription or translation. As another example, a polling application can be configured to process video data and to look for gestures indicative of a vote (e.g., such as thumbs-up and/or down gesture, head nod, and/or the like). As a further example, a sign language application can process video data to generate closed captioning data based on detected signs in the video. As another example, a video segmentation application can process video data to segment one or more items out of the video data (e.g., to segment out a person, object, shape, and/or the like).

The applications running within the tiles of a room can be maintained in a persistent manner, such that the applications can be stateful. As described herein, a virtual machine application can be maintained in a persistent manner. The techniques also allow for other applications to similarly be maintained in a persistent manner so that the state of the applications can be kept in a stateful manner across various rooms and/or room events. For example, assume a user opens a room and opens two tiles: a tile with a cloud browser tile and a note application tile. The user then works with the browser and note application, such as searching various web pages (e.g., and generating a web history), and typing notes in the note application. It can be desirable for the user to be able to close out of the room, and to be able to re-open the room with the browser tile and notes tile apps (e.g., at a different day, different time, etc.) with the same state as when the user closed the room.

In some embodiments, the techniques can store data (e.g., artifacts, along with other necessary data) of the various applications and associated states for the tiles of a room. For example, for applications provided natively by the system (e.g., such as a notes application), the system can be configured to store the necessary information and persist that information in the database for subsequent use. If a user opens a room that references a persisted application, the system can be configured to auto-load the application each time an end user opens or rejoins the room. In some embodiments, a room can be configured to open a persisted application using metadata. For example, the system can store application metadata about a room (e.g., in the system DB and/or in a memory caching layer). The stored metadata information can include, for example, the statefulness of an application (e.g., whether or not it should be opened when the room is launched along with the state of the application the last time the room was used). In some embodiments, when a user launches a room, the system can look up the associated metadata within the appropriate data storage layers. If the metadata indicates the tile should be reconstructed using a persisted application, the system can read the metadata and dynamically construct the tile so that the tile resembles its previous, persisted state.

In some embodiments, such as for cloud based applications that are not native to the system, the system can be configured to leave the applications running in a detached state. A detached state can be, for example, an external system (e.g., virtual machine) that is left running but is not piping data into a room (e.g., because no one is in the room). As described herein, the system can persist information about the location of the detached application/VM and associate it with the appropriate room. The system can maintain a list of the detached applications using the system's persistent database. When a user opens or rejoins a room associated with a running application, the system can identify/look up the detached application(s) and programmatically reattach them in a seamless fashion. In some embodiments, such as for external applications/VMs, the stored metadata can include the IP address and port of where the detached instance/application/VM is running. When a user re-enters the room and/or starts the room, the system can look up the metadata and re-attach the application/VM to the room in the form of a tile.

Allowing persistent applications can expand the platform to additional use cases. For example, as explained herein, persistent applications can be used to provide a cloud-based computing environment, which can include not only virtual machines, but also other applications available through the system. As another example, users can collaborate together both while in the same room, as well as by sharing a room URL. For example, a user can open up a few applications in the room and set up the content of those applications, and then send the room URL to another user. That other user can then subsequently (e.g., without the first user being involved), open the room using the URL and pick up the content of those applications where they were left off by the first user.

A template configuration can be specified to provide a pre-specified, custom configuration of a tiling layout for a room (e.g., prior to launching the room in a browser). In some embodiments, the template specifies configurations such as the number of tiles that should exist in a room, the location of each tile when the room is launched/joined from the template, the content source of each tile, whether the applications associated with the content are persistent, and/or the like. Regarding the content source, for example, a user can specify in a template that a certain PDF document is opened in a first tile that is oriented on the left half of the browser display, and that a browser tile oriented in the right-half of the browser display is open to a particular URL. Regarding the persistence of the applications, users can choose at the individual application level whether each application will be stateful across sessions (e.g., which a user can change as desired). In some embodiments, content can be associated with a template. For example, a PDF file can be associated with a template, such that if the PDF file in the template is updated, all rooms opened with that template will launch a tile with the modified PDF. Therefore, template configurations can be used to specify a master layout of a room, which can be used for any rooms that incorporate the template. Thus, a user can quickly create and launch a room from an existing template with the single click of a button.

As discussed herein, in some embodiments one or more applications can be provided by the cloud computing environment 108. In some embodiments, one or more applications (e.g., such as a transcription application and/or other type of application that operates on content from the applications) can be provided by the media server 202. In some embodiments, each computing device may have a connection (e.g., a WSS connection) to the media server 202, such that the computing device(s) stream data to the media server 202 for processing. The media server 202 can be configured to use the connections with the computing devices to transfer any resulting data back to the computing devices. For example, for a transcription application, the computing device streams audio data to the transcription server, the transcription server transcribes the audio data, and the transcription server sends the transcript to the connected computing devices (via the connection between the transcription server and the computing devices).

In some embodiments, applications provided within the cloud computing environment 108 can be running in the background (e.g., even if there are no associated tiles with the various connected computing devices). Any resulting data, such as a transcript in the example of a transcription application, can be stored in the database 210. In some embodiments, applications can be configured to use a publish/subscribe messaging protocol. The applications and related services provided by the cloud computing platform 108 can be loosely coupled using a pub/sub architecture. For example, when the transcription application has transcribed data that is available for use, the transcription application can publish a message for any applications that will process or use the transcription data (e.g., whether it be a database application configured to store any transcriptions, and/or other applications that can process the transcribed data). In some embodiments, the signaling server can control whether to display a tile with the transcript. For example, if a room user turns on transcription for the room, the signaling server can transmit data to each computing device connected to the room to turn on the transcription tile, which can cause each computing device to connect to the media server, establish a connection with the media server to receive the data, and to render the received data in an associated transcription tile.

In some embodiments, each tile in a display runs without knowledge of, or reliance on, other tiles of the display. For example, while a tile can be designed such that the associated application uses data from other applications, the tiles of a particular display need not know anything about the other tiles running (e.g., in the web browser) and/or where the associated data for the tile is received from. For example, if a new computing device joins a room using peer-to-peer videoconferencing, the computing device connects to the signaling server, the signaling server pings out to all current computing devices that the new computing device joined, and each computing device creates a peer-to-peer connection with the new computing device. Upon successful establishment of the peer-to-peer connections, each computing device receives an audio and video stream from the new user, creates a new tile in the web browser or application display, and adds the tile to the existing tiling architecture. However, the existing tiles on each computing device need not be made aware of the new tile. The web browser/application may include a user interface manager that manages each tile to support dragging, dropping, resizing, and/or the like as discussed herein.

FIG. 4E shows an exemplary configuration of the tiles of web browser display 400, according to an embodiment of the present application. As shown, tiles 402A-C are associated with a cloud video conferencing application, and therefore tiles 402A-C display the associated video data received from the cloud video conferencing application. The tiles 402A-C can also interface with a sound device of the computing device (e.g., speakers, headphones, and/or the like) to play the associated audio data from the video conferencing application. Tile 404 is associated with a cloud computer application. As discussed herein, the cloud computing application can be a virtual machine application. Tile 406 is associated with a text summarization application, and tile 408 is associated with an audio transcription application. Tile 408 can display the transcript of the videoconference. Tile 406 can display a summary of the transcript of the video conference. As discussed herein, the text summarization application can use the transcript (e.g., generated internally by the cloud computing environment).

Referring to step 308 of FIG. 3, in some embodiments, a room can be shared with other users so that the other users can join the room. In some embodiments each room is associated with a URL. For example, the user that created the room can share the URL with other users so that they can join the room. In some embodiments, the platform can provide security for rooms. For example, a room can be an unsecured/unlocked room so that anyone can join the room, and/or the room can be a secured/locked to control access to the room. For example, a secure room can require that each user first be invited to join the room (e.g., such that the user is associated with an access list for the room). In some embodiments, security can be added on a per-application basis and/or on a per-artifact basis. In some embodiments, the platform can provide different levels of access, such as a viewer access mode (e.g., where the user can only view the applications associated with the room), an admin mode (e.g., where the user can not only view the applications, but can also edit the applications), and/or the like.

In some embodiments, a user can choose to share tiles on a per-tile basis. The computing device can receive a command to share a selected tile from a plurality of displayed tiles (e.g., by the user selecting a share button associated with the tile). The computing device can transmit data associated with the content of the selected tile to the signaling server, and the signaling server can transmit the data to other computing devices connected to the room.

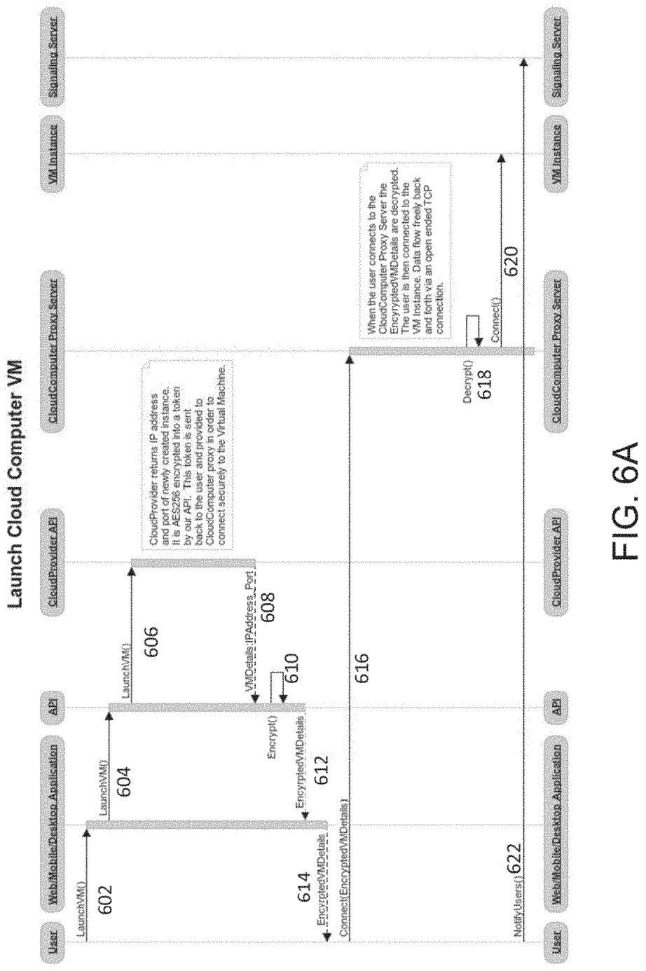

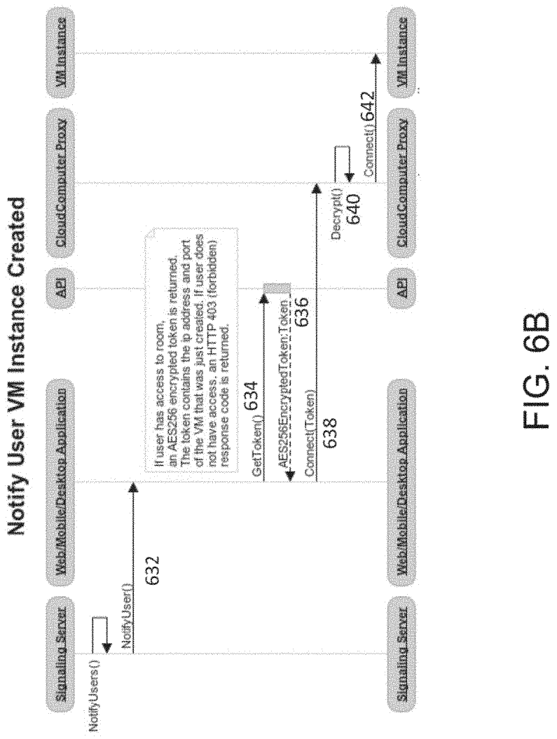

FIGS. 6A-6B show an exemplary messaging flow for a virtual machine web enabled application, according to some embodiments. At step 602, the user of a computing device launches the web application. The web application can be any device for which applications can be programmed as discussed herein, and/or that can run a browser, as discussed herein, such as a desktop and/or a mobile device. At step 604, the web application transmits a message to the API server to launch a virtual machine. At step 606, the API server transmits a message to the cloud API (in this example, an Amazon Web Services API) to launch a virtual machine. At step 608, the cloud API returns the IP address and port of the newly created virtual machine instance. For security, at step 610 the API server can encrypt the IP address and port using an encryption technology, such as AES256 encryption, to generate a token. At step 612, the API server can transmit the encrypted virtual machine details to the web application running on the user's computing device. At step 614, the user receives the encrypted virtual machine details.

At step 616, the computing device connects to the proxy server. At step 618, the proxy server (e.g., a cloud computer proxy server) decrypts the encrypted token to determine the IP address and port of the running virtual machine. The proxy server can obtain the required information to decrypt the token from the API server, and can be configured to decrypt the token only if the user has access to the room. At step 620, the proxy server connects to the VM instance using the decrypted IP address and port information.

At step 622, the signaling server notifies users of the room that the virtual machine is available. As discussed herein, the signaling server can be used to perform the actual communication with the computing devices (e.g., where the proxy server is configured to decrypt the token and to route users to the appropriate virtual machine). At step 632, the signaling server notifies the other computing devices. At step 634, the web application for each computing device obtains the token from the API server, which transmits an encrypted token to each requested computing device at step 636 if the user has access to the room (otherwise a HTTP 403 error message is returned). At step 638, the computing devices connect to the proxy server, which decrypts the received token at step 640, and connects the computing device to the virtual machine at step 642.

As discussed herein, the various users of a room can all control the virtual machine. While not shown in FIGS. 6A-6B, a remote access program can be run by the cloud computing environment 108. For example, the server can be a Virtual Network Computing (VNC) server. The remote access program can be configured to provide the virtual machine emulation, such as emulating the mouse/cursor, and sending related data to all the participants that are involved with the virtual machine.

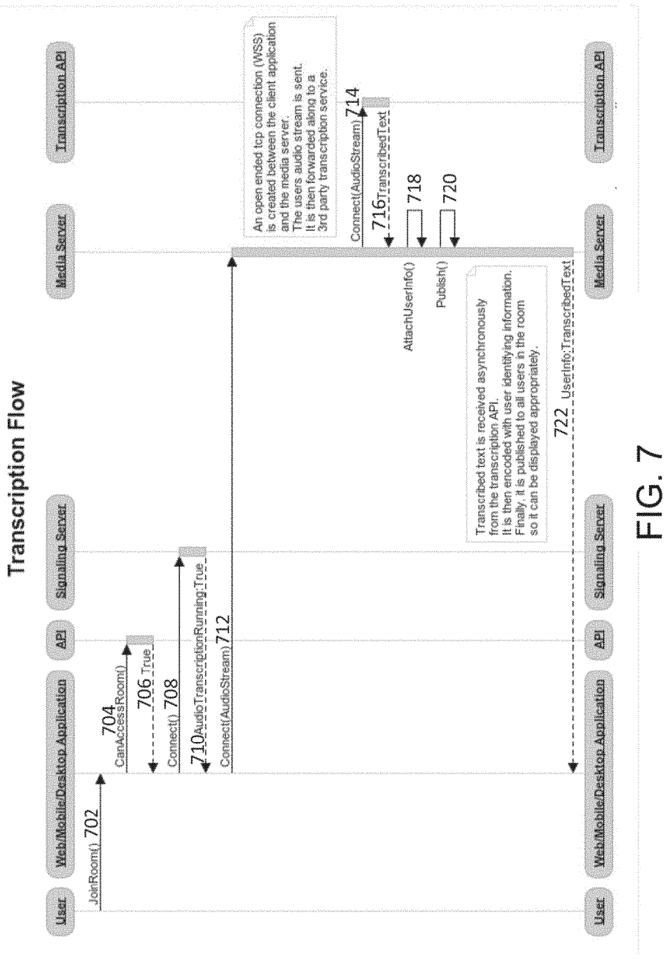

FIG. 7 shows an exemplary messaging flow for a transcription application, according to an embodiment of the present application. At step 702, a user joins a room via an associated application (e.g., a web, mobile, desktop application, and/or the like). At step 704, the application communicates with the API to determine whether the user can access the room (e.g., if the user has been granted access to a locked room). At step 706, the API returns an indication to the application that the user can access the room. At step 708, the user connects to the room via the signaling server. At step 710, the signaling server notifies the user's application that the audio transcription is running. At step 712, the application connects to the media server to provide the audio stream. In this example, an open ended TCP connection (e.g., WSS) is created between the client application and the media server. The application sends the user's audio stream to the media server using the connection. At step 714, the media servers forwards the audio stream along to a third party transcription service using a transcription API. At step 716, the transcription service provides the transcribed text to the media server. At step 718, the media server attaches the user information to the transcribed text. At step 720, the media server publishes to subscribed applications that transcribed text is available (e.g., using a pub/sub architecture). At step 722, the media server sends the transcribed text to subscribed applications.

Depending on the nature of the computing device, one or more additional elements may be present. For example, a smart phone or other portable electronic device may include a camera, capable of capturing still or video images. In some embodiments, a computing device may include sensors such as a global positioning system (GPS) to sense location and inertial sensors such as a compass, an inclinometer and/or ran accelerometer. The operating system may include utilities to control these devices to capture data from them and make the data available to applications executing on the computing device.

As another example, in some embodiments, a computing device may include a network interface to implement a personal area network. Such an interface may operate in accordance with any suitable technology, including a Bluetooth, Zigbee or an 802.11 ad hoc mode, for example.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present application are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present application can be implemented in any of numerous ways. For example, the disclosed method may be applied to techniques described herein to provide web enabled applications, including tiled displays that can provide tiles associated with both local and/or remote content, and that can facilitate sharing one or more tiles among a group of computing devices connected to a particular room.

For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format. In the embodiment illustrated, the input/output devices are illustrated as physically separate from the computing device. In some embodiments, however, the input and/or output devices may be physically integrated into the same unit as the processor or other elements of the computing device. For example, a keyboard might be implemented as a soft keyboard on a touch screen. Alternatively, the input/output devices may be entirely disconnected from the computing device, and functionally integrated through a wireless connection.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present application as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “code”, “program” or “software” are used herein in a generic sense to refer to any type of computer code or set of computer-executable instructions that can be employed to program a computer or other processor to implement various aspects of the present application as discussed above. Additionally, it should be appreciated that according to one aspect of this embodiment, one or more computer programs that when executed perform methods of the present application need not reside on a single computer or processor, but may be distributed in a modular fashion amongst a number of different computers or processors to implement various aspects of the present application.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present application may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A system for executing web-based applications, the system comprising one or more processors configured to:
execute, using a web browser, a set of applications, wherein each application is associated with a content source, the content source comprising a local content source running locally on the system, a remote content source running remotely from the system, or both; and
display, using the web browser, a plurality of tiles, wherein each tile is associated with an application from the set of applications, and each tile displays content from the content source of the associated application.

2. The system of claim 1, wherein the one or more processors are configured to:
receive a command to share a selected tile from the plurality of tiles with a second system that is remote from the system; and
transmit data associated with the content of the selected tile to a remote server over a network, wherein the server is configured to transmit the data to the second system.

3. The system of claim 1, wherein executing, using the web browser, a set of applications comprises:
transmitting a request to a remote server over a network to join an online room associated with the set of applications;
establishing a connection to the remote server to join the online room;
receiving content for an application of the set of applications from the remote server; and
displaying the content in the tile associated with the application.

4. The system of claim 3, wherein the application is an online video conferencing application, and displaying the content in the tile associated with the online video conferencing application comprises:
receiving audio data, video data, or both, associated with a remote system;
displaying the audio data, video data, or both in the tile associated with the online video conferencing application;
generating, by the one or more processors, local audio data, local video data, or both; and
transmitting the local audio data, local video data, or both.

5. The system of claim 4, wherein transmitting comprises transmitting the local audio data, local video data, or both, to the remote server so that the remote server can transmit the local audio data, local video data, or both to the remote system.

6. The system of claim 4, wherein transmitting comprises:
establishing a peer-to-peer connection with the remote system; and
transmitting the local audio data, local video data, or both, to the remote system using the peer-to-peer connection.

7. The system of claim 1, wherein an application of the set of applications comprises a virtual machine application, wherein executing the virtual machine application comprises:
transmitting a request to a remote server to launch a virtual machine;
receiving data indicative of information regarding the virtual machine, wherein the virtual machine is running remotely from the system; and
connecting to the virtual machine using the received data.

8. The system of claim 7, wherein the one or more processors are configured to:
receive a command to share the tile from the plurality of tiles associated with the virtual machine application with a second system that is remote from the system; and
transmit data to the remote server over a network, wherein the server is configured to connect the second system to the virtual machine application.

9. The system of claim 7, wherein the one or more processors are configured to:
determine the web browser is closed by a user; and
maintaining the virtual machine in a running state, such that the virtual machine can be displayed in a new tile launched at a later time.

10. A system for executing web-based applications, the system comprising one or more processors configured to:
store, in a database, a set of rooms, wherein each room is associated with a set of applications, and each room can be joined by a plurality of remote systems to collaborate using the set of applications;
receive a request from a remote system to connect to a room from the set of rooms;
start the room, comprising:
executing the set of applications, wherein each application generates associated artifacts during execution; and
connecting the remote system to the set of applications so that the remote system can receive content associated with the set of applications;
receive a request from a second remote system to connect to the room;
connect the second remote system so to the set of applications so that the second remote system can receive the content associated with the set of applications;
determine the remote system and second remote system disconnected from the room;
terminate the room; and
store the artifacts generated by the set of applications.

11. The system of claim 10, wherein the one or more processors are configured to:
receive a request from a third remote system to play back the artifacts associated with the room; and
transmit the artifacts to the third remote system for display in a web browser associated with the third remote system.

12. The system of claim 10, wherein executing the set of applications comprises:
executing a first application that generates first content; and
executing a second application that processes the first content to generate second content.

13. The system of claim 12, wherein executing the first application comprises executing a video conferencing application that generates the first content, and the first content comprises video data, audio data, or both.

14. The system of claim 13, wherein executing the second application comprises executing a visual recognition application that generates the second content based on the video data, wherein the second content comprises data regarding a detected visual aspect of the video data.

15. The system of claim 13, wherein executing the second application comprises executing a video segmentation application that generates the second content based on the video data, wherein the second content comprises second video data that is segmented according to the video segmentation application.

16. The system of claim 13, wherein executing the second application comprises executing a transcription application that generates the second content based on the audio data, wherein the second content comprises a transcription of the audio data.

17. A computer-implemented method for executing web-based applications, the method comprising:
storing, in a database, a set of rooms, wherein each room is associated with a set of applications, and each room can be joined by a plurality of remote systems to collaborate using the set of applications;
receiving a request from a remote system to connect to a room from the set of rooms;
starting the room, comprising:
executing the set of applications, wherein each application generates associated artifacts during execution; and
connecting the remote system to the set of applications so that the remote system can receive content associated with the set of applications;
receiving a request from a second remote system to connect to the room;
connecting the second remote system so to the set of applications so that the second remote system can receive the content associated with the set of applications;
determining the remote system and second remote system disconnected from the room;
terminating the room; and
storing the artifacts generated by the set of applications.

18. At least one non-transitory computer-readable storage medium comprising computer-executable instructions that, when executed by at least one processor of a system, perform a method to execute web-based applications, the method comprising:
storing, in a database, a set of rooms, wherein each room is associated with a set of applications, and each room can be joined by a plurality of remote systems to collaborate using the set of applications;
receiving a request from a remote system to connect to a room from the set of rooms;
starting the room, comprising:
executing the set of applications, wherein each application generates associated artifacts during execution; and
connecting the remote system to the set of applications so that the remote system can receive content associated with the set of applications;
receiving a request from a second remote system to connect to the room;
connecting the second remote system so to the set of applications so that the second remote system can receive the content associated with the set of applications;
determining the remote system and second remote system disconnected from the room;
terminating the room; and
storing the artifacts generated by the set of applications.

19. A computer-implemented method for executing web-based applications, the method comprising:
executing, using a web browser, a set of applications, wherein each application is associated with a content source, the content source comprising a local content source running locally on the system, a remote content source running remotely from the system, or both; and
displaying, using the web browser, a plurality of tiles, wherein each tile is associated with an application from the set of applications, and each tile displays content from the content source of the associated application.

20. At least one non-transitory computer-readable storage medium comprising computer-executable instructions that, when executed by at least one processor of a system, perform a method to execute web-based applications, the method comprising:
executing, using a web browser, a set of applications, wherein each application is associated with a content source, the content source comprising a local content source running locally on the system, a remote content source running remotely from the system, or both; and
displaying, using the web browser, a plurality of tiles, wherein each tile is associated with an application from the set of applications, and each tile displays content from the content source of the associated application.
